(19) United States
(12) Patent Application Publication
(10) Pub. No.: US 2013/0042509 A1
(43) Pub. Date: Feb. 21, 2013

(54) METHOD AND SYSTEM FOR PRODUCING GREETING CARDS

(71) Applicants: Lee William Hawkins, Kent (GB); Peter Socrates Dudley-Ryder, Kent (GB)

(72) Inventors: Lee William Hawkins, Kent (GB); Peter Socrates Dudley-Ryder, Kent (GB)

(21) Appl. No.: 13/588,181

(22) Filed: Aug. 17, 2012

(30) Foreign Application Priority Data
Aug. 18, 2011 (GB) 1114252.8

(51) Int. Cl. G09F 1/00; G06Q 30/00

(52) U.S. Cl. 40/124.01; 705/26.5

(57) ABSTRACT

The present invention relates to a system for producing a greeting card. The system comprises user devices and a server with a communications network which are configured for capturing handwriting as a digital image, processing the digital image to extract the handwriting, combining the processed image with one of a number of images for the greeting card, and controlling the display of the combined image on a user device or the printing of the combined image.

### FIELD OF INVENTION

The present invention is in the field of producing greeting cards. In particular, but not exclusively, the present invention relates to a method and system for producing greeting cards for electronic display or physical printing.

### BACKGROUND

Greeting cards are sent between people as expressions of friendship, condolence, love, or other sentiment, or to mark a special event. Greeting cards typically contain a design on the outside of the card, and often a design or pre-printed message within the card. The sender of the card will usually write a message within the card.

Greeting cards are typically purchased in person at a physical store.

In the last few years, some online providers enable a sender to send a digital/virtual greeting card. For a digital greeting card, an email is typically sent to the recipient. The email may contain the digital greeting card or it may contain a URL to the digital greeting card.

Digital greeting cards can be personalised by the sender typing messages for display within the digital greeting card.

However, digital greeting cards can still seem impersonal. Therefore, there exists a need for a system which provides greater personalisation of a digital greeting card by a sender.

Physical greeting cards are generally prepared and sent by the sender. However, it is not unknown for physical greeting cards to be prepared and sent by an intermediary organisation. For example, florists receiving an order for flowers and a card via the phone or Internet can enter a message from the sender into the card. The disadvantage of intermediaries sending cards is that the writing within the card is either typed or in the handwriting of the intermediary/employee of the intermediary.

Therefore, there also exists a need for a system which provides greater personalisation of remotely prepared physical greeting cards by a sender.

It is an object of the present invention to provide a system for producing greeting cards which overcomes the disadvantages of the prior art, or at least provides a useful alternative.

### SUMMARY OF INVENTION

According to a first aspect of the invention there is provided a method of producing a greeting card within a communications network, including the steps of:

a) a first user device capturing writing on a physical medium as a digital image;
b) processing the digital image to extract the writing;
c) the server extracting one of a plurality of pre-stored greeting card images from a database;
d) combining the processed image with the extracted image;
e) the server storing the combined image in a database; and
f) upon receiving a request over a communications network, the server controlling the display of the combined image on a second user device to produce a virtual greeting card or controlling the printing of the combined image on a physical medium to produce a physical greeting card.

The writing may be handwriting or a hand-drawn image.

The method may include a third user device receiving manipulation information from the user regarding the relationship between the processed image and the greeting card image. The processed image may be combined with the extracted image in accordance with the manipulation information.

The method may include the third user device receiving an image derived from the processed image and an image derived from the greeting card image and the third user device displaying the derived images to assist the user in providing the manipulation information. The derived images may be lower resolution versions of the original images.

The first user device may capture the writing using an internal camera.

The method may include a fourth user device displaying at least some of the plurality of pre-stored greeting card images and the fourth user device receiving input from a user to select one of the plurality of pre-stored greeting card images. The server may extract the one of the plurality of pre-stored greeting card images in accordance with the selection by the user.

The server may control the display of the combined image on the second user device by transmitting a derivative of the combined image to the second user device.

The step of processing of the digital image may be performed by the server or an image processor collocated with the server.

The step of combining the processed image with the extracted image may be performed by the server.

One or more of the user devices may be the same device. For example, the first and second user devices may be the same device.

The request may originate from the second user device.

According to a further aspect of the invention there is provided a system for producing a greeting card, including:

a first user device including a capture device configured to capture writing on a physical medium as a first digital image and a communications module configured to communicate over a communications network with a server;
a second user device including a display device and a communications module configured to communicate over a communications network with a server;
a server including a database configured to store a plurality of greeting card images and to store a combined image, and a processor configured to extract one of the plurality of greeting card images, to combine a second digital image with the extracted greeting card image to form a combined image, to store the combined image in the database, and, in response to a request received over a communications network, to transmit an image derived from the combined image for either display on the second user device as a virtual greeting card or for printing on a printing device as a physical greeting card; and
an image processor configured to process the first digital image into the second digital image by extracting the writing.

According to a further aspect of the invention there is provided a method of producing a greeting card, including:

a) a user capturing a handwritten message as an image using an apparatus;
b) the user interacting with an apparatus to select one of a plurality of greeting card designs, wherein at least some of the greeting card designs comprise different designs inside the greeting card;
d) an apparatus modifying the selected greeting card by combining the image with the inside of the greeting card; and
e) an apparatus transmitting the modified greeting card for printing or for display on a user device.

According to a further aspect of the invention there is provided a system for producing a greeting card, including:

an apparatus for capturing a handwritten message as an image;
an apparatus for receiving user input to select one of a plurality of greeting card designs, wherein at least some of the greeting card designs comprise different designs inside the greeting card;
an apparatus for modifying the selected greeting card by combining the image with the inside of the greeting card; and
an apparatus for transmitting the modified greeting card for printing or for display on a user device.

Each apparatus may comprise a processor connected to a memory. Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flowchart illustrating a method in accordance with an embodiment of the invention;

FIG. 3a: shows a diagram illustrating a method in accordance with an embodiment of the invention;

FIG. 3b: shows a diagram illustrating a method in accordance with an embodiment of the invention; and

FIG. 4: shows a diagram illustrating the manipulation of images by a user in accordance with an embodiment of the invention.

### DETAILED DESCRIPTION OF PREFERRED EMBODIMENTS

The present invention provides a method and system for producing greeting cards in a communications network.

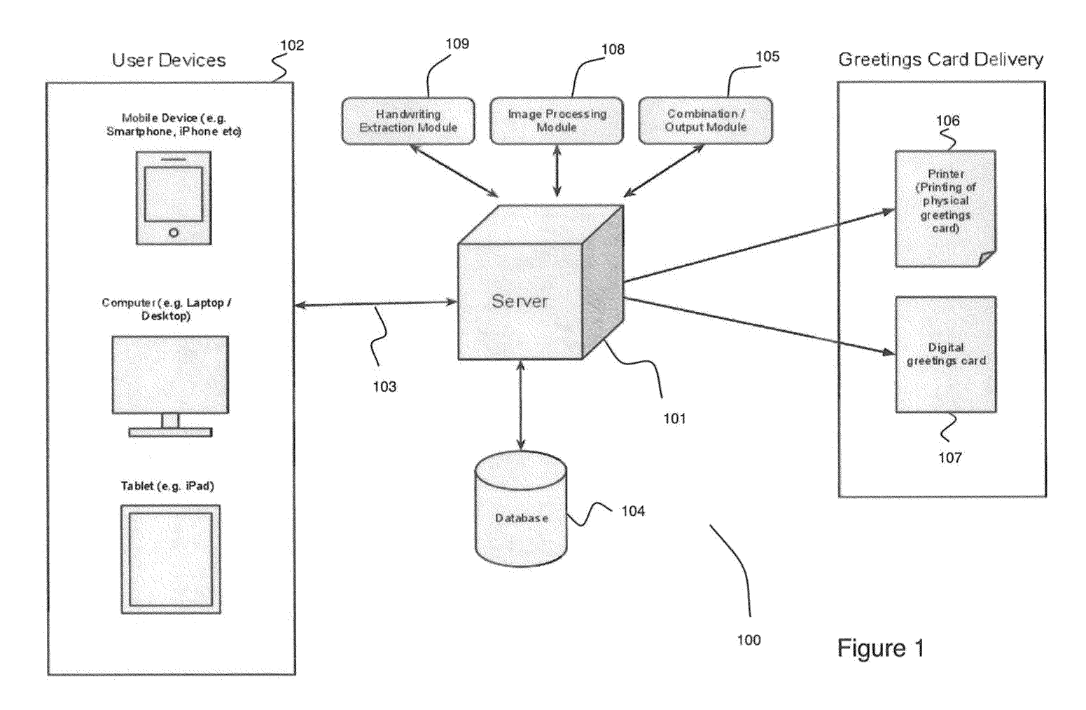

In FIG. 1, a system 100 for producing greeting cards is shown. The system 100 includes a server 101. The server 101 includes a communications network interface for communicating with a plurality of user devices 102 via a communications network 103. The user devices 102 may be mobile devices, such as cellular mobile telephones or tablet computers, or computing devices, such as laptop or desktop computers.

At least one of the user devices 102 interfaces with a capture device such as an external/internal camera, or scanner. The interface may be an indirect interface, for example, with an external camera via the memory card of the external camera within a memory card reader.

At least one of the user devices 102 may include a display device such as a screen.

The server 101 includes a database 104 for storing card design images.

The database 104 may also store digitised message images and/or processed message images.

The server 101 may include a processor 105 for combining the processed message images and the card design images, a control system for controlling the printing 106 of the combined images, and a control system for controlling the display 107 of the combined images, or derivatives of the combined images, upon request by a user device 102.

The server may also include an image processing module 108 for processing images to produce an image derivative. In one embodiment, the processing comprises generating a low resolution image from a high resolution image.

The system 100 further includes a processor 109 for processing digital images to extract handwriting from the image. The processor 109 may be a component of the server 101, a user device 102, or it may be part of a second server specifically configured for the processing of digital images.

The system 100 may include a printing system for generating physical copies of the greeting cards.

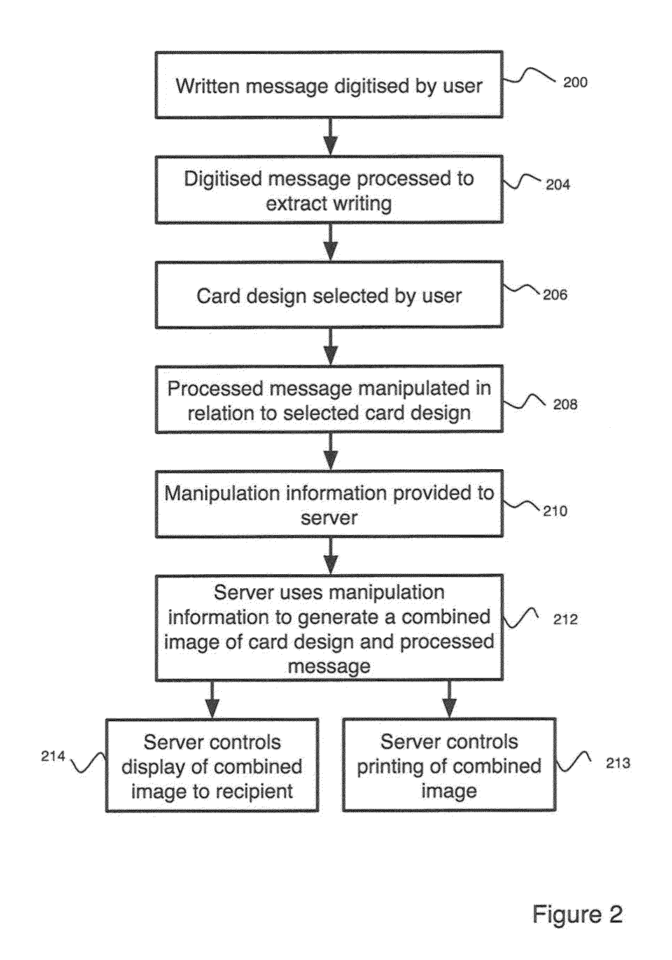

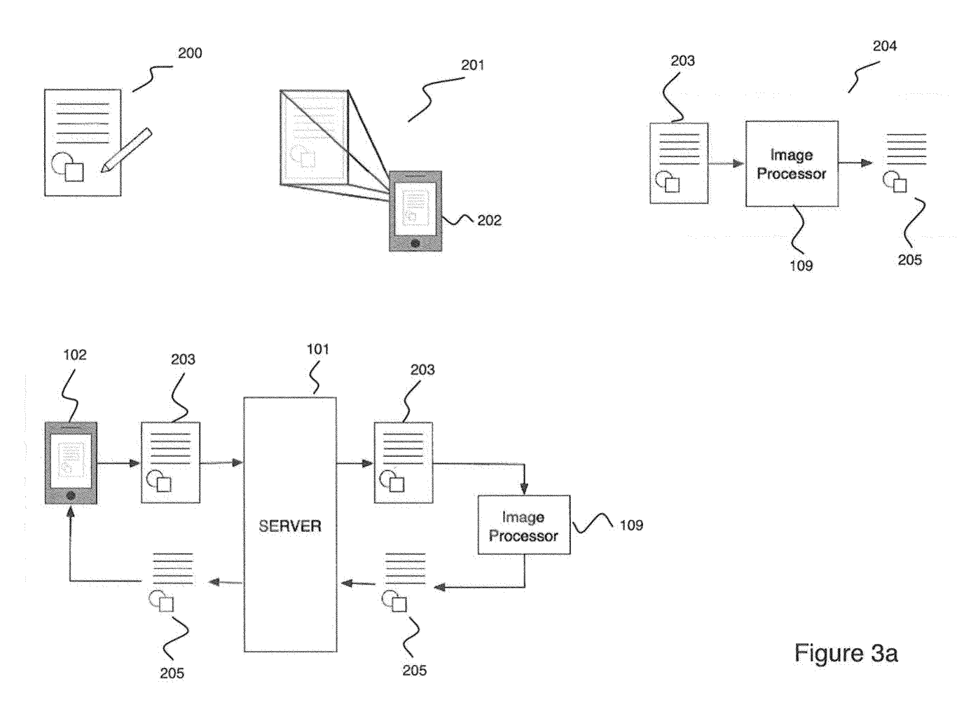

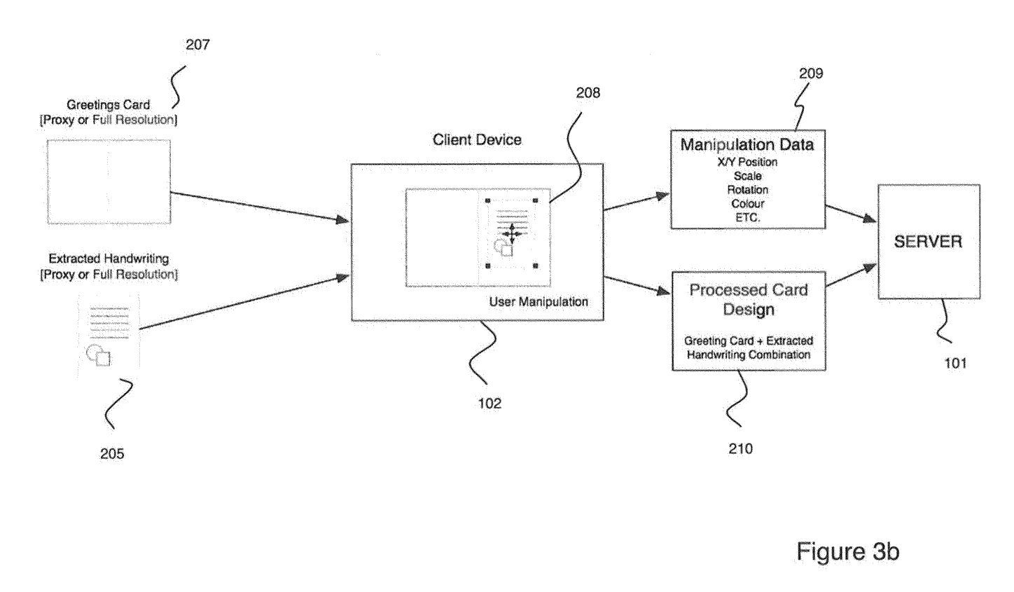

With reference to FIGS. 2, 3a and 3b, a method for producing greeting cards will be described.

A user writes 200 a message for a recipient. For example, by writing using pen or pencil on paper. The message may be text, pictorial or a combination of both.

The user digitises 201 the handwritten message using an image capture device 202 such as a digital camera, a scanner, or a camera on a mobile phone. The image capture device 202 may be a user device 102, or the digitised message may be transmitted to a user device 102.

The digitised message 203 is then processed 204 using a handwriting extraction processor 109. The processor 109 may be at the server 101. In one embodiment, the processor 109 is at the user device 102 and the digitised message 203 is processed at the user device 102.

When the digitised message 203 is processed at the server 101, the digitised message 203 may be transmitted by the user device 102 over a communications network 103 to the server 101. The user device 102 may transmit the digitised message 203 using any one of the following methods: email, mobile application—web or native, web application, desktop application, FTP, or any other method of file upload.

The processing involves the extraction of the handwritten message from the digitised image. Extraction of the handwritten message may involve numerous processing steps such as:
a) applying a smoothing filter, such as a Gaussian filter, to the digitised image;
b) generating a colour or luminance histogram from the smoothed digitised image;
c) applying thresholding to distinguish the background from the writing; and
d) deleting all pixels from the digitised image that fall within the background threshold.

It will be appreciated that other steps could also be used such as a convolution filter. In one embodiment, an edge detection algorithm such as the Canny edge detection algorithm could be used to identify the handwritten message within the digitised image.

Where the digitised message 203 is processed at the server, the processed message image 205, or a derivative of the processed message image—for example, a lower resolution version of the image, is transmitted to a user device 102.

The user may also select 206 a card design 207. Possible card designs may be provided by a server 101 and displayed on a user device 102 for selection. The user may change/select the card design at any time. The selection of the card design may be transmitted to a server.

The selected card design image 206 may be transmitted by the server to the user device. Alternatively, a derivative of the selected card design image may be transmitted back to the user device 102, for example, a lower resolution version of the card design image may be transmitted.

The user may manipulate 208 the processed message image 205 in relation to the card design image 207. For example, for positioning, resizing, or colouring the processed message image 205.

The manipulation results in manipulation information 209, for example, x/y coordinates of the relative position of the message image within the card design image, scaling information of the message image, rotation, and colour information for the writing.

The manipulation information 209 may be transmitted 210 to the server 101. Alternatively, the user device 102 may combine the processed handwriting and the card design 211 using the manipulation information and transmit the combined image back to the server 101. In one embodiment, the user device 102 may transmit the combined image to another server such as an image storage server or to a recipient device via a file transmission mechanism, such as email, over a communications network.

The server 101 may utilise the manipulation information 209 when combining 212 the processed message image 205 and the card design image 207.

The combined image, or a derivative of the combined image—for example, a lower resolution version, may be transmitted back to the user device 102 for the user to confirm the combined image.

The server 101 may then control 213 the printing of the combined image to produce physical versions of the greeting card for posting to the recipient(s).

The server 101 may also store the combined image in a database 104 and upon a request from a user device of the recipient(s) may control the transmission and display 214 of the combined image, or a derivative thereof, on the user device of the recipient(s).

In one embodiment, the server 101 may control the transmission and display of the combined image, or a derivative thereof, on the user device of the recipient(s) in response to a request from a user device of the sender. For example, the sender may request that the combined image is emailed to the recipient.

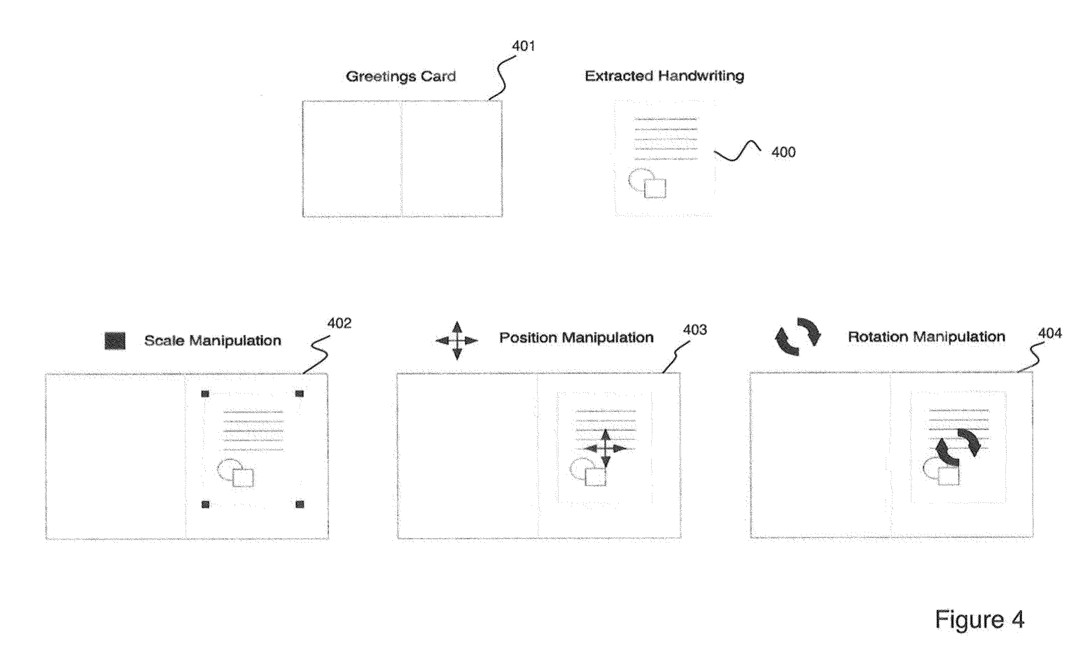

FIG. 4 shows a diagram of how a user can manipulate the captured handwriting 400 within the background image 401 of the card design. Scale manipulation 402, position manipulation 403, and rotation manipulation 404 are shown within a user interface.

It will be appreciated that the present invention may be implemented as software executing on computer hardware or within hardware itself.

A potential advantage of some embodiments of the present invention is that as the server combines the writing and the background images, high resolution images can be generated because less information is required to be transmitted from the sender user device to the server. This results, for example, in higher resolution print quality of the greeting cards or higher resolution of the display of the greeting cards on the recipient user device.

Another potential advantage of some embodiments of the present invention is that as the server controls the combination of the writing and the greeting card image, and the display and printing of the combined image, the security of the writing can be protected. One possible consequence of improved security is less complex security mechanisms need be employed between the server and the recipient user device.

Another potential advantage of some embodiments of the present invention is that as because the captured image is processed to extract the writing of the sender, this may result in lower hardware requirements for the image capture device, improve the quality of the resulting combined image, and/or result in image characteristics which produce higher image compression.

Another potential advantage of some embodiments of the present invention is the greater personalization of greeting cards sent using a digital device.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art.

Therefore, the invention in its broader aspects is not limited to the specific details, representative apparatus and method, and illustrative examples shown and described. Accordingly, departures may be made from such details without departure from the spirit or scope of applicant's general inventive concept.

1. A method of producing a greeting card within a communications network, including:
a) a first user device capturing writing on a physical medium as a digital image;
b) processing the digital image to extract the writing;
c) the server extracting one of a plurality of pre-stored greeting card images from a database;
d) combining the processed image with the extracted image;
e) the server storing the combined image in a database; and
f) upon receiving a request over a communications network, the server controlling the display of the combined image on a second user device to produce a virtual greeting card or controlling the printing of the combined image on a physical medium to produce a physical greeting card.

2. A method as claimed in claim 1 further including:
a third user device receiving manipulation information from the user regarding the relationship between the processed image and the greeting card image; wherein the processed image is combined with the extracted image in accordance with the manipulation information.

3. A method as claimed in claim 2 further including:
the third user device receiving an image derived from the processed image and an image derived from the greeting card image; and
the third user device displaying the derived images to assist the user in providing the manipulation information.

4. A method as claimed in claim 3 wherein the derived images are lower resolution versions of the original images.

5. A method as claimed in claim 1 wherein the first user device captures the writing using an internal camera.

6. A method as claimed in claim 1 further including:
a fourth user device displaying at least some of the plurality of pre-stored greeting card images; and
the fourth user device receiving input from a user to select one of the plurality of pre-stored greeting card images;
wherein the server extracts the one of the plurality of pre-stored greeting card images in accordance with the selection by the user.

7. A method as claimed in claim 1 wherein the first user device and the second user device are the same device.

8. A method as claimed in claim 1 wherein the server controls the display of the combined image on the second user device by transmitting a derivative of the combined image to the second user device.

9. A method as claimed in claim 1 wherein the step of processing of the digital image is performed by the server.

10. A method as claimed in claim 1 wherein the step of combining the processed image with the extracted image is performed by the server.

11. A method as claimed in claim 1 wherein the request originates from the second user device.

12. A system for producing a greeting card, including:
a first user device including a capture device configured to capture writing on a physical medium as a first digital image and a communications module configured to communicate over a communications network with a server;
a second user device including a display device and a communications module configured to communicate over a communications network with a server;
a server including a database configured to store a plurality of greeting card images and to store a combined image, and a processor configured to extract one of the plurality of greeting card images, to combine a second digital image with the extracted greeting card image to form a combined image, to store the combined image in the database, and, in response to a request received over a communications network, to transmit an image derived from the combined image for either display on the second user device as a virtual greeting card or for printing on a printing device as a physical greeting card; and
an image processor configured to process the first digital image into the second digital image by extracting the writing.

13. A system as claimed in claim 12 further including:
a third user device configured to receive manipulation information from the user regarding the relationship between the second digital image and the extracted greeting card image; and wherein the server is further configured to combine the second digital image with the extracted greeting card image in accordance with the manipulation information.

14. A system as claimed in claim 13 wherein the third user device is further configured to receive an image derived from the second digital image and an image derived from the extracted greeting card image and to display the derived images to assist the user in providing the manipulation information.

15. A system as claimed in claim 14 wherein the derived images are lower resolution versions of the original images.

16. A system as claimed in claim 12 wherein the first user device captures the writing using an internal camera.

17. A system as claimed in claim 12 further including:
a fourth user device configured to display at least some of the plurality of pre-stored greeting card images; and
a fourth user device configured to receive input from a user to select one of the plurality of pre-stored greeting card images;
wherein the server is further configured to extract the one of the plurality of pre-stored greeting card images in accordance with the selection by the user.

18. A system as claimed in claim 12 wherein the first user device and the second user device are the same device.

19. A system as claimed in claim 12 wherein the server controls the display of the combined image on the second user device by transmitting a derivative of the combined image to the second user device.

20. A system as claimed in claim 12 wherein the image processor is collocated with the server.

21. A system as claimed in claim 12 wherein the request is received from the second user device.

22. A method of producing a greeting card, including:
a) a user capturing a handwritten message as an image using an apparatus;
b) the user interacting with an apparatus to select one of a plurality of greeting card designs, wherein at least some of the greeting card designs comprise different designs inside the greeting card;
d) an apparatus modifying the selected greeting card by combining the image with the inside of the greeting card; and
e) an apparatus transmitting the modified greeting card for printing or for display on a user device.

23. A system for producing a greeting card, including:
an apparatus for capturing a handwritten message as an image;
an apparatus for receiving user input to select one of a plurality of greeting card designs, wherein at least some of the greeting card designs comprise different designs inside the greeting card;
an apparatus for modifying the selected greeting card by combining the image with the inside of the greeting card; and
an apparatus for transmitting the modified greeting card for printing or for display on a user device.

24. A computer program product configured to perform the method of claim 1.

25. A medium configured to store a computer program product of claim 24.

26. A greeting card produced by the method of claim 1.
